(19) United States
(12) Patent Application Publication
(10) Pub. No.: US 2025/0319748 A1
(43) Pub. Date: Oct. 16, 2025

(54) AIR VENT

(71) Applicant: Faurecia Innenraum Systeme GmbH, Hagenbach (DE)

(72) Inventors: Volker DOLL, Ranschbach (DE); Stephane LONDICHE, Montmagny (FR); Julien SEILLER, Munich (DE); Martin SCHULZ, Karlsruhe (DE)

(21) Appl. No.: 19/251,409

(22) Filed: Jun. 26, 2025

Related U.S. Application Data
(63) Continuation of application No. 18/510,266, filed on Nov. 15, 2023, now Pat. No. 12,365,223.
Application No. 18/510,266 is a continuation of application No. 17/486,463, filed on Sep. 27, 2021, now Pat. No. 11,878,573.
Application No. 17/486,463 is a continuation of application No. 16/228,145, filed on Dec. 20, 2018, now Pat. No. 11,400,795.
Application No. 16/228,145 is a continuation of application No. 14/887,055, filed on Oct. 19, 2015, now Pat. No. 10,195,924.
Application No. 14/887,055 is a continuation of application No. 14/257,344, filed on Apr. 21, 2014, now Pat. No. 9,163,848.

(30) Foreign Application Priority Data
May 29, 2013 (DE) 10 2013 210 053

(51) Int. Cl. B60H 1/34; F24F 7/04; F24F 13/072

(52) U.S. Cl. CPC B60H 1/3421; B60H 1/3414; B60H 1/345; F24F 7/04; F24F 13/072; B60H 2001/3492

(57) ABSTRACT

An air vent is configured to discharge two separate volumetric flows of air in respectively different and intersecting discharge directions. An illuminator provides illumination that is visible to a user of the air vent at an air outlet of the air vent. The illuminator is disposed within or adjacent a housing of the air vent, between the air outlet and a vane of the air vent, or along an air duct of the air vent. A perceived air discharge direction is adjustable with no change in the intersecting discharge directions.

### TECHNICAL FIELD

The invention relates to an air vent for vehicles.

### BACKGROUND

Various air vents are known from the prior art. DE 10 2006 032587 A1, for example, discloses an air outlet device for vehicles, which comprises—as viewed in a longitudinal or vertical section—an air duct having a first, upper wall region and, facing this, a second, lower wall region, and which is fluidically connected via an air outlet opening to a passenger compartment of the vehicle. Air can be directed into the passenger compartment via the air duct and the air outlet opening. At least one louver-type air guide element is disposed between the two wall regions in the region or the vicinity of the air outlet opening.

### SUMMARY

Embodiments of an air vent include a housing and air ducts configured to discharge two separate volumetric flows of air in respectively different and intersecting discharge directions. An illuminator provides illumination that is visible to a user of the air vent at an air outlet of the air vent.

The air vent may include one or more of the following features in any technically feasible combination:
the illuminator is disposed within the housing;
the illuminator is disposed adjacent to the housing;
the illuminator is disposed between the air outlet and a first vane and/or a second vane;
the illuminator is located along one of the air ducts;
each air duct is defined in part by a respective air guide surface spaced from an inner surface of the housing with the illuminator being located between the air guide surfaces;
the air ducts include first and second air ducts configured to discharge the two separate volumetric flows of air in the respectively different and intersecting discharge directions with the illuminator being located between the first and second air ducts;
the illuminator is located along a third air duct between first and second air ducts;
a perceived air discharge direction is vertically adjustable with no change to the intersecting discharge directions;
a vane that is moveable to adjust a perceived air discharge direction with no change to the intersecting discharge directions, the vane optionally being: located along one of the air ducts, not visible to a user of the air vent when the air vent is viewed from the air outlet, moveable to vertically adjust the perceived air discharge with no change to the intersecting discharge directions, moveable to horizontally adjust the perceived air discharge direction;
a vane that is moveable to horizontally adjust a perceived air discharge direction and an additional vane that is moveable to vertically adjust the perceived air discharge with no change to the intersecting discharge directions;
a vane located along one of the air ducts and not visible to a user of the air vent when the air vent is viewed from the air outlet;
a manipulator operatively coupled to a vane to move the vane to vertically and/or horizontally change the perceived air discharge direction;
the air ducts include first and second air ducts each defined at least in part between an inner wall of the housing and respective first and second air guide surfaces with each air guide surface being in a fixed position with respect to the housing;
the first and second directions are each defined at least in part by a shape of an inner wall of the housing and a shape of an air guide surface facing said inner wall and having a fixed position with respect to the housing.

### BRIEF DESCRIPTION OF THE DRAWINGS

Preferred embodiments of the invention are explained in the following in greater detail by reference to the drawings. In the drawings:

FIG. 1 shows a schematic view of an air vent.

FIG. 2 shows another schematic view of the air vent from FIG. 1.

FIG. 3 shows a perspective view of an air vent.

FIG. 4 shows a lateral sectional view of the air vent from FIG. 3.

FIG. 5 shows a sectional view of the air vent from FIG. 3, from above.

### DETAILED DESCRIPTION

Elements that are similar to one another are labeled with the same reference signs in the following.

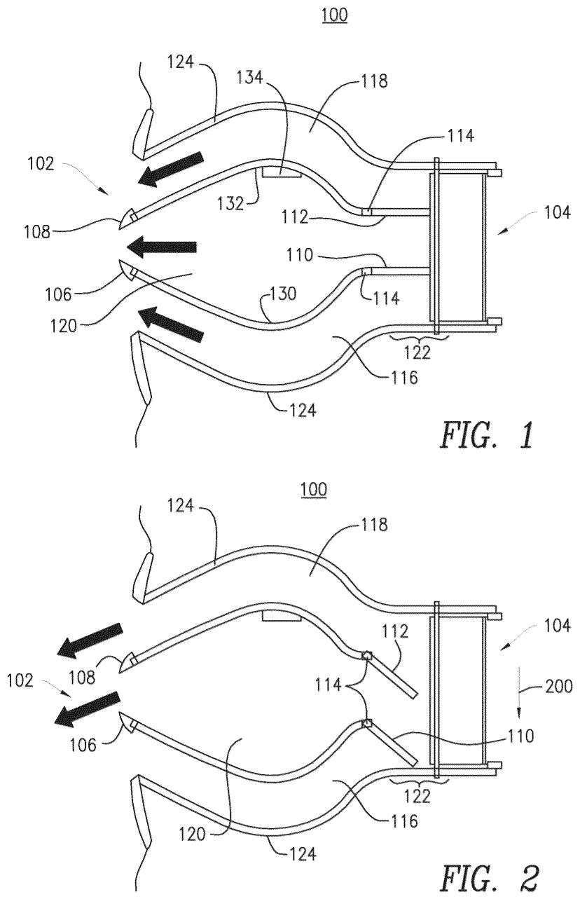

FIG. 1 is a schematic view of an air vent 100 comprising a housing 124. The air vent has an air inlet opening 104, which is disposed in the axial direction of the housing, and a corresponding air outlet opening 102. The air inlet opening 104 and the air outlet opening 102 are disposed opposite one another as viewed in the axial direction of the housing 124.

Air guide surfaces 106 and 108, which are located in the housing 124, are also clearly shown. Both air guide surfaces 106 and 108 have rounded bulges 130 and 132, respectively, which point in opposite directions, namely vertically upward and downward in FIG. 1. These two directions are opposed to one another and extend perpendicularly to the axial direction of the housing 124. The air guide surfaces 106 and 108 are disposed at a distance from the inner side of the housing 124, thereby forming an air duct 116 between the air guide surface 106 and the interior of the housing 124 and, analogously, an air conduit 118 is formed between the air guide surface 108 and the interior of the housing 124. The inner side of the housing 124 extends parallel to the shape of the air guide surfaces 106 and 108.

A further air duct 120 is formed between the air guide surfaces 106 and 108. If air then flows into the housing 124 from the air inlet opening 104, this air will then flow through the air ducts 116, 118 and 120, as indicated by the directions of the arrows in FIG. 1, and will emerge from the air outlet opening 102. The emerging volumetric flows will mix in a corresponding manner, and therefore the air flow felt at the air outlet opening 102 will be perceived as an air flow that is directed straight ahead.

In order to change the direction of this emerging air flow in the vertical direction, i.e. to deflect this emerging air flow upwardly or downwardly, a vane 110 or 112 is mounted on the air guide surfaces 106 and 108, respectively, via corresponding axes 114. The vanes 110 and 112 can be swiveled in the direction 200 or opposite the direction 200 by means of the axial hinge-connection thereof, as in the example depicted in FIG. 2.

In FIG. 2, the vanes 110, 112 are swiveled downward about the axis 114 in the direction 200. As a result, the lower air duct 116 is completely closed by the vane 110. The air entering the housing 124 through the air inlet opening 104 can therefore flow only through the air ducts 120 and 118. Due to the bulged shape thereof, and due to the downward slant of the vane 112, the air flow emerging from the air outlet opening 102 is oriented in the downwardly slanted direction.

According to this example, it is therefore possible to control the air flow between various outwardly flowing directions by positioning the vanes 110 and 112 appropriately, without the related air guide components—i.e. the vanes 110 and 112—being visible by an observer from the side of the air outlet opening 102.

This makes it possible, for example, to accommodate an appropriate illuminator 134 within the housing 124, which can provide diffuse illumination of the air vent 100 in darkness. The illumination provided by the illuminator 134 is consistent regardless of the position of the vane 110 or 112, which can make it easier to operate the air vent 100 from the sides of the air outlet opening 102.

The vanes 110 and 112 and the housing 124 have a rectangular shape in the region 122 of the vanes 110 and 112. This makes it possible to easily implement the swivel motion of the vanes 110, 112 without the vanes and the inner walls of the housing 124 interfering with one another.

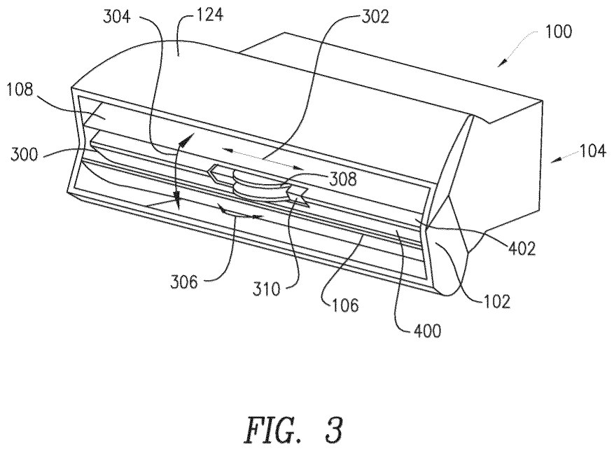

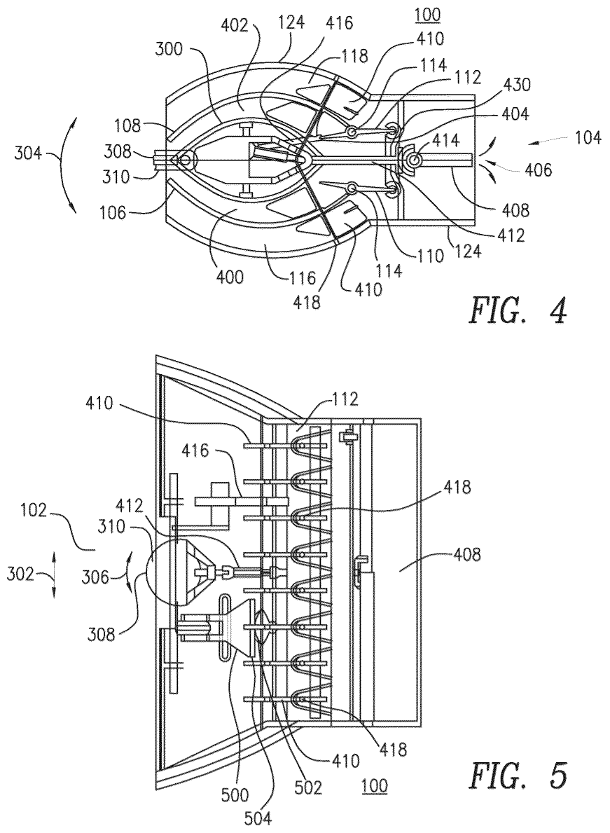

FIG. 3 shows a further variant of an air vent 100, wherein, as compared to the variant shown in FIGS. 1 and 2, a closed air guide element 300 was selected in this case instead of an air duct between the air guide surfaces 106 and 108. This air guide element, in combination with the air guide surfaces 106 and 108, delimits additional air ducts 400 or 402, as shown in FIG. 4 in particular. Further air ducts 400 and 402 are now provided in addition to the aforementioned air ducts 116 and 118.

FIG. 3 also shows a manipulator 310, which can be swiveled vertically in direction 304 relative to the air guide element 300 rigidly disposed on the housing 124. Furthermore, the manipulator 310 shown in FIG. 3 can be moved in direction 302 horizontally to the left and right relative to the air guide element 300. Finally, the manipulator 310 also comprises a rotatable positioning aid 308, which can be rotated horizontally relative to the manipulator 310 in direction 306.

FIG. 4 shows a lateral sectional view through the air vent 100 depicted in FIG. 3. In addition to the air guide elements 106 and 108, the vanes 110 and 112 known from FIGS. 1 and 2 are shown once more. These, in turn, are disposed on the air guide elements 106 and 108 by means of axes 114, wherein, in the present case, the axes are not disposed at the ends of the vanes 110 or 112, but rather slightly closer to the center relative to the respective vanes, although not necessarily being centered.

A first end of one of the vanes 112 is mechanically connected to the manipulator 310, and a second end of the same vane 112, which is diametrically opposed to the first end, is mechanically coupled to the other vane 110 via a coupling 430. Movement of the manipulator 310 in direction 304 induces a transfer of force between the manipulator 310 and one of the vanes 112, which induces rotation of that vane 112 about the axis 114 thereof due to the coupling between the manipulator 310 and the first end of the vane 112. At the same time, the rotation also induces a displacement of the coupling 430 upwardly or downwardly in the vertical direction and, therefore, a corresponding rotation of the other vane 110 about the axis 114 thereof. It is thereby possible to adjust a related volumetric flow through the air ducts 116, 400, 402 and 118.

The mechanical coupling between the manipulator 310 and the first end of the vane 112 is implemented, for example, via a corresponding coupling rod 416.

FIGS. 3 and 4 furthermore show a closing element 408, which is formed of two plates. These plates are supported on the housing 124 via a common axis 414. By means of a rotational motion of the positioning aid 308 in the horizontal direction, a force can be transferred to the plates of the closing element 408 via a coupling rod 412. By means of this force, the plates can be swiveled in the housing 124 opposite to direction 406. By means of this swiveling, the air inlet opening 104 can be completely closed or opened. One of the plates therefore swivels upwardly in the closing procedure, as shown in FIG. 4, while the other plate swivels downwardly, in direction 406, in the closing procedure.

This procedure and the corresponding mechanical connection are explained in greater detail with reference to FIG. 5, which shows a sectional illustration of the air vent 100 of FIG. 3, from above.

FIG. 5 more clearly shows the positioning aid 308, which can be rotated in direction 306. The rotation occurs relative to the manipulator 310. Rotation of the positioning aid 308 in direction 306 causes the axis between the positioning aid 306 and the closing element 408 in FIG. 5 to move easily in the horizontal plane. The movement of this axis 412 causes a gearwheel disposed between the axis 412 and the closing element 408 to induce a corresponding rotation of the plates of the closing element 408 about the axis 414. Compensation of the length of the coupling rod 412, which may be required therefor, can be implemented by means of components of the coupling rod 412, which can be slid into one another.

FIG. 4 also shows a set of further vanes 410, which are hinge-connected at an axis 418. The view in FIG. 5 clearly shows that these vanes 410, after rotation about the axis 418, can change the directional characteristic of the air flowing out of the air outlet opening 102. While the vanes 110 and 112, according to FIG. 3, are responsible for a directional characteristic in the vertical direction, the vanes 410 define the directional characteristic of the outflowing air in the horizontal direction.

The orientation of the vanes 410 relative to the housing is induced by the manipulator 310 in that this manipulator is displaced in a translatory manner in the horizontal direction 302. A coupling element 500, which is rigidly connected to the manipulator 310, comprises a toothed rack 504, in which a gearwheel 502 engages. In turn, this toothed rack 504 is rigidly connected to the vanes 410. As a result, when the manipulator 310 moves in direction 302, relative motion between the toothed rack 504 and the gearwheel 502 takes place, which, in turn, induces rotation of the vanes 410 about the axes 418 thereof. It is therefore possible to change the directional characteristic of an emerging air flow in the vertical and horizontal directions by means of a single manipulator.

1. An air vent, comprising:
a housing;
air ducts configured to discharge two separate volumetric flows of air in respectively different and intersecting discharge directions; and
an illuminator to provide illumination that is visible to a user of the air vent at an air outlet of the air vent.

2. The air vent of claim 1, wherein the illuminator is disposed within the housing.

3. The air vent of claim 1, wherein the illuminator is disposed adjacent to the housing.

4. The air vent of claim 1, wherein the illuminator is disposed between the air outlet and a first vane and/or a second vane.

5. The air vent of claim 1, wherein the illuminator is located at least partly along one of the air ducts.

6. The air vent of claim 1, wherein each air duct is defined in part by a respective air guide surface spaced from an inner surface of the housing, the illuminator being located at least partly between the air guide surfaces.

7. The air vent of claim 1, wherein the air ducts include first and second air ducts configured to discharge the two separate volumetric flows of air in the respectively different and intersecting discharge directions, the illuminator being located between the first and second air ducts.

8. The air vent of claim 7, wherein the illuminator is located along a third air duct.

9. The air vent of claim 1, wherein a perceived air discharge direction is vertically adjustable with no change to the intersecting discharge directions.

10. The air vent of claim 1, further comprising a vane that is moveable to adjust a perceived air discharge direction with no change to the intersecting discharge directions.

11. The air vent of claim 10, wherein the vane is located along one of the air ducts.

12. The air vent of claim 10, wherein the vane is not visible to a user of the air vent when the air vent is viewed from the air outlet.

13. The air vent of claim 10, wherein the vane is moveable to vertically adjust the perceived air discharge with no change to the intersecting discharge directions.

14. The air vent of claim 10, wherein the vane is moveable to horizontally adjust the perceived air discharge direction with no change to the intersecting discharge directions.

15. The air vent of claim 14, further comprising an additional vane that is moveable to vertically adjust the perceived air discharge with no change to the intersecting discharge directions.

16. The air vent of claim 15, wherein each vane is located along one of the air ducts and is not visible to a user of the air vent when the air vent is viewed from the air outlet.

17. The air vent of claim 15, further comprising a manipulator operatively coupled to one of the vanes to move the vane to vertically or horizontally change the perceived air discharge direction with no change to the intersecting discharge directions.

18. The air vent of claim 17, wherein the manipulator is operatively coupled to each of the vanes to move each vane to vertically and horizontally change the perceived air discharge direction with no change to the intersecting discharge directions.

19. The air vent of claim 1, wherein the air ducts include first and second air ducts each defined at least in part between an inner wall of the housing and respective first and second air guide surfaces, each air guide surface being in a fixed position with respect to the housing.

20. The air vent of claim 1, wherein the first and second directions are each defined at least in part by a shape of an inner wall of the housing and a shape of an air guide surface facing said inner wall and having a fixed position with respect to the housing.
